(19) United States
(12) Patent Application Publication
(10) Pub. No.: US 2010/0195057 A1
(43) Pub. Date: Aug. 5, 2010

(54) PROJECTION SYSTEMS FOR ACTIVITY BASED USERS

(75) Inventors: Jeff Nash, Oakland, CA (US); Winston Shih, New York, NY (US)

Correspondence Address: KENYON & KENYON LLP, 1500 K STREET N.W., SUITE 700, WASHINGTON, DC, 20005, US

(73) Assignee: The North Face Apparel Corp., Wilmington, DE (US)

(21) Appl. No.: 11/957,774

(22) Filed: Dec. 17, 2007

(51) Int. Cl. G03B 21/10; G03B 21/00

(52) U.S. Cl. 353/28; 353/122; 353/43; 353/79

(57) ABSTRACT

A projection system for displaying information which may include an electronic device and a projector connected to the electronic device. The electronic device and projector can be positioned on an article of clothing and/or an outdoor recreational product to project information therefrom. The article of clothing and/or outdoor recreational device may include a screen to enhance the projected information. The projector may be in connection with a power source.

### TECHNICAL FIELD

The present application generally relates to projection systems for projecting information from electronic devices configured for use with articles of clothing and/or outdoor recreational apparatuses.

### BACKGROUND

Currently, electronic interfaces that may be used in articles of clothing and/or outdoor recreational products involve audio interfaces. For example, soft textile controllers may be used to operate portable media players and wireless devices. When using such controllers, display of information, such as song titles, artist, and/or caller ID, is not currently available. This is due, in part, to limitations with respect to display technologies (e.g., flexible screens, electronic ink, etc).

In order to address the drawbacks associated with current display technologies, certain embodiments of the present application use a nano-projector to project, rather than display, information. Moreover, certain embodiments of the present application include nano-projectors which use lasers/LEDs, which can reduce the size of the projector, while at the same time reducing power consumption and heat output.

### BRIEF DESCRIPTION

The present application is directed to projection systems for projecting information from electronic devices configured for use in articles of clothing and/or outdoor recreational products.

Certain embodiments of the present application regard an article of clothing comprising a projection system for projecting information. The system may comprise an electronic device and a projector connected to the electronic device. The electronic device and projector can be positionable on the article of clothing to project information therefrom.

Other embodiments of the present application relate to an outdoor recreational product comprising a projection system for projecting information. The projection system may comprise an electronic device and a projector connected to the electronic device. The electronic device and projector can be positionable on the device to project information therefrom.

The application may be embodied by numerous other devices and methods. The description provided herein, when taken in conjunction with the annexed drawings, discloses examples of the application. Other embodiments, which incorporate some or all steps as taught herein, are also possible.

### BRIEF DESCRIPTION OF THE DRAWINGS

Referring to the drawings, which form a part of this disclosure:

FIG. 1 shows an article of clothing including a projection system for projecting information as may be employed in accordance with certain embodiments of the present application;

FIGS. 2a-b show projector devices that may be employed in accordance with certain embodiments of the present application;

FIG. 3 shows the article of clothing of FIG. 1 with and without the projection system for projecting information positioned thereon;

FIG. 4 shows electronic devices that may be employed in accordance with certain embodiments of the present application;

FIG. 5 shows an outdoor recreational product including a projection system as may be employed in accordance with embodiments of the present application;

FIG. 6 shows examples of outdoor recreational devices that may be used in accordance with certain embodiments of the present application; and

FIGS. 7-9 show various examples of using the projection system for projecting information as may be employed in accordance with certain embodiments of the present application.

### DETAILED DESCRIPTION

The present application generally relates to projection systems for projecting information which may include an electronic device and a projector connected to the electronic device. The electronic device and projector can be positioned on an article of clothing and/or an outdoor recreational product to project information therefrom.

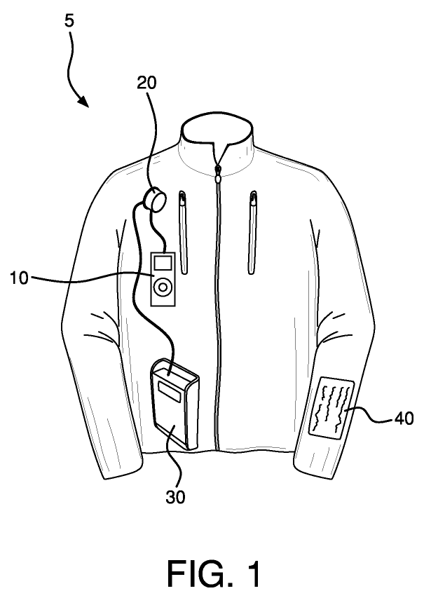

Referring initially to FIG. 1, it can be seen that certain embodiments of the present application can relate to articles of clothing 5 which may include a system for projecting information. The system can comprise an electronic device 10 and a projector 20 connected to the electronic device 10. The electronic device 10 and/or projector 20 may be in communication with a power source 30. Further, a screen 40 may be disposed on a portion of the article of clothing, in this case a sleeve of a jacket, to enhance projection of images.

As stated hereinabove, the electronic device 10 and projector 20 can be positioned on an article of clothing to project information therefrom. In the example, the article of clothing is a jacket; however, any article of clothing may be used including shirts, pants, etc. The article of clothing may include pockets, compartments, attachment clips, etc., sized to support the electronic device 10, projector 20, power source 30, and/or screen 40. All of the aforementioned components 10, 20, 30, 40 may also be detachably removed.

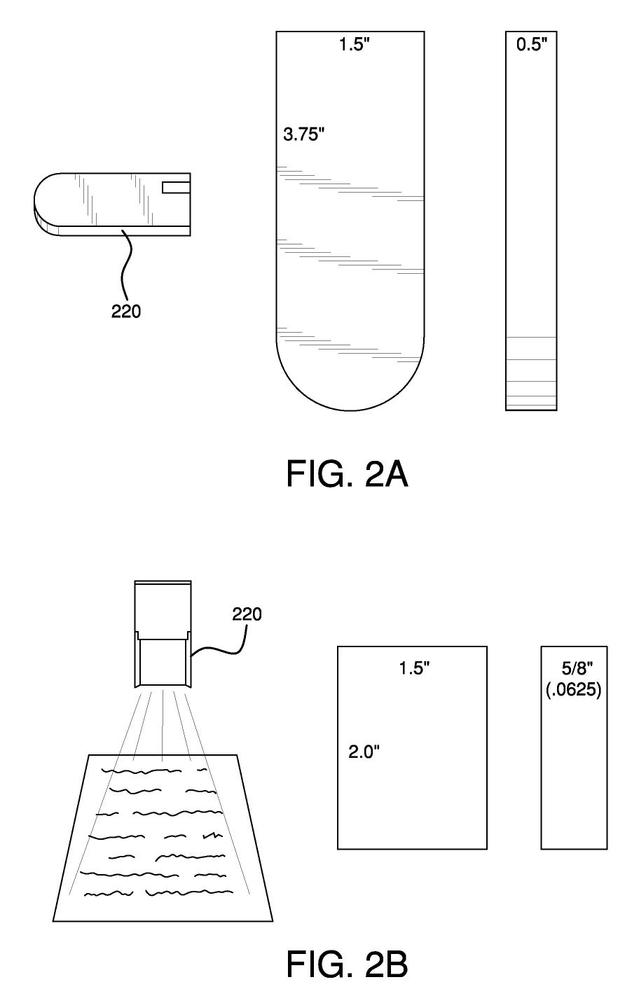

As seen in FIGS. 2a-b, a projector 220 is shown. The projector 220 can include an LED and/or a laser. Since the projector 220 uses LED and/or laser technology, lighter parts may be used and cooling fans may be omitted.

In the examples shown, since an incandescent light bulb is not being used, the size of the projector 220 can be reduced. For instance, in the example shown in FIG. 2a, the projector 220 is 3.75 inches long, 1.5 inches wide, and 0.5 inches thick. Of course, other dimensions may be used. For example, as shown in FIG. 2b, a rectangular shaped projector 220 is shown having a length of 2.0 inches, a width of 1.5 inches, and is 0.0625 inches thick.

In certain examples, the projector 220 has a projection distance of 1.0 to 9.0 feet long, however, other ranges may be used. In other examples, the size of the image projected may be between 7.0-63.0 inches, measured diagonally, however, other image sizes may be used. The projector 220 may project information onto the ground and/or onto a surface such as a wall.

One example of suitable projectors that may be used in accordance with embodiments of the present application are nano-projectors manufactured by ExPlay™ Technologies of Israel; however, any suitable projector that projects information, such as black and white alphanumeric information, may be used.

The projectors size and weight may be preferably minimized for the following: integration into apparel or equipment (may also be removable); useable for outdoor environment and related seasonal conditions; and useable for activities such as trekking, trail running, skiing, and snowboarding. Projectors in accordance with certain embodiments of the present application can be used to project simple, text, static information (snapshot) from a electronic device being used during activity. For example, the projector may project black and white alphanumeric characters, may have low refresh rates, low resolution, minimal power consumption, and additional functionality can be considered with sensitivity to impact on system's size, weight, cost, complexity, development lead time. Likewise, the projector may project color, have a high refresh rate, high resolution, and increased power consumption if desired. Still other arrangements are possible.

In accordance with certain embodiments of the present application, the projector may include standard input and output interfaces on the projector to allow connection to a variety of electronic devices with the use of adaptors where necessary. These connections can allow inherent projector signals from the electronic device to be passed to the projector. In addition, the electronic device may be interfaced to CD devices having audio outputs.

In accordance with other embodiments, the projector may incorporate cables for power, video, and/or audio. Further, the projector may also be wireless for video, audio and operation control.

Projectors which may be used in outdoor environments can be preferably durable. For example, they are preferably designed to withstand high ambient temperatures of up to around 120° F. and low ambient temperatures of around −20° F. Further, the projector may be preferably designed to withstand moist/wet environments (e.g., degree of water resistance), constant shock impact (e.g., related to running), and/or dust/dirt.

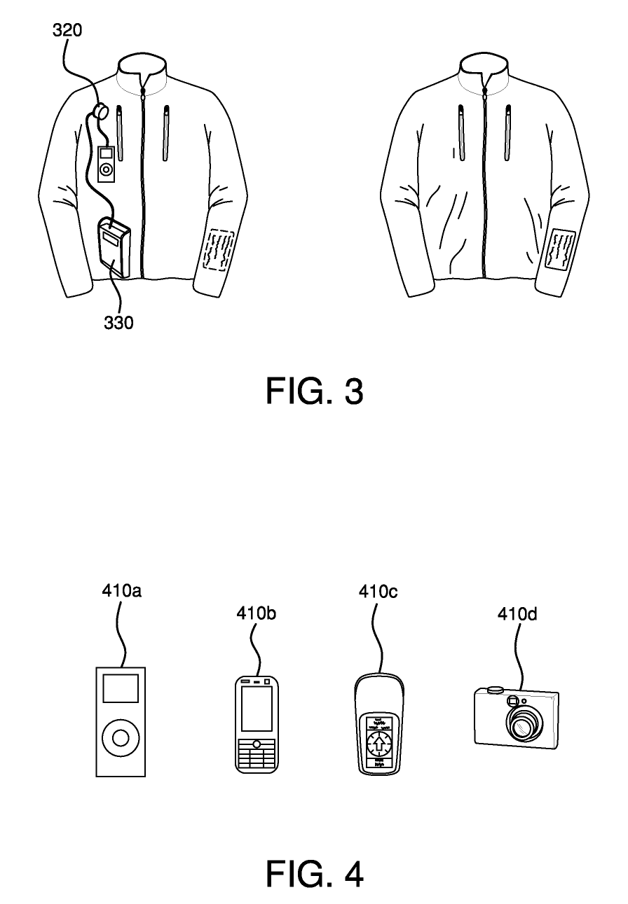

As seen in FIG. 3, the projector 320 may be in connection with a power source 330. The power source 330 may be a battery, such as a re-chargeable lithium ion battery, and/or can be solar powered. FIG. 3 also illustrates that the projection system may be removed from the article of clothing.

FIG. 4 shows examples of electronic devices that may be used in accordance with embodiments of the present application. Suitable electronic devices may include, but are not limited to, portable media players 410a, wireless personal area networks, cell phones 410b, global positioning systems 410c, personal digital assistants, and cameras 410d.

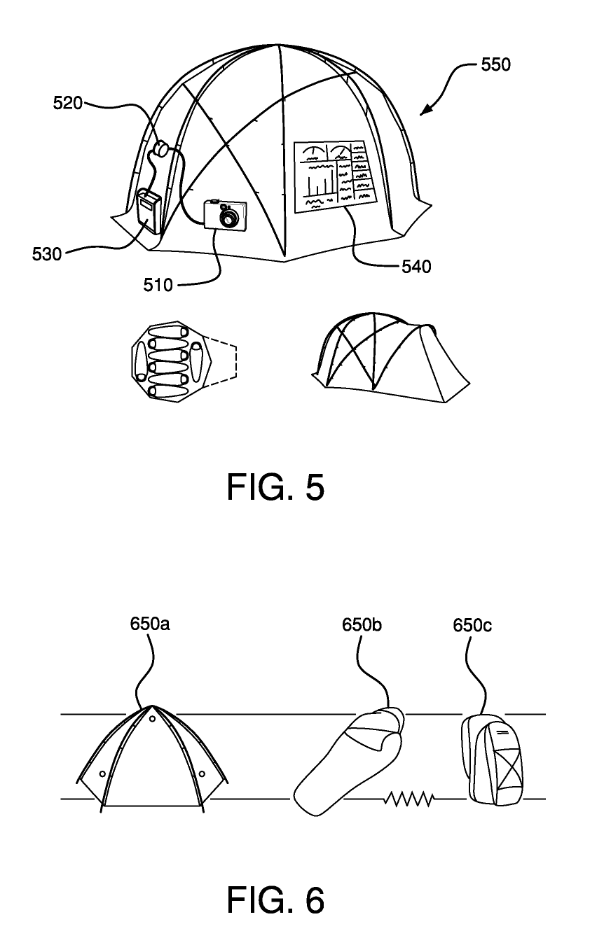

FIG. 5 shows an outdoor recreational apparatus 550 including a projection system as may be employed in accordance with other embodiments of the present application. As with FIG. 1, described hereinabove in detail, the projection system includes a electronic device 510 and projector 520 which can be positioned on the outdoor recreational apparatus 550 to project information therefrom. In the example, the outdoor recreational apparatus is a tent; however, any apparatus may be used including sleeping bags, backpacks, etc. As with FIG. 1, the system may optionally include a power source 530 and/or screen 540. The outdoor recreational apparatus 550 may include pockets, compartments, attachment clips, etc., sized to support the electronic device 510, projector 520, power source 530, and/or screen 540. All of the aforementioned components 510, 520, 530, 540 may also be detachably removed.

FIG. 6 shows examples of outdoor recreational apparatuses for which the system of projecting information in accordance with certain embodiments of the present application may be used. For example, in the example, a tent 650a, sleeping bag 650b, and backpack 650c are shown; however, other outdoor recreational apparatuses may be used.

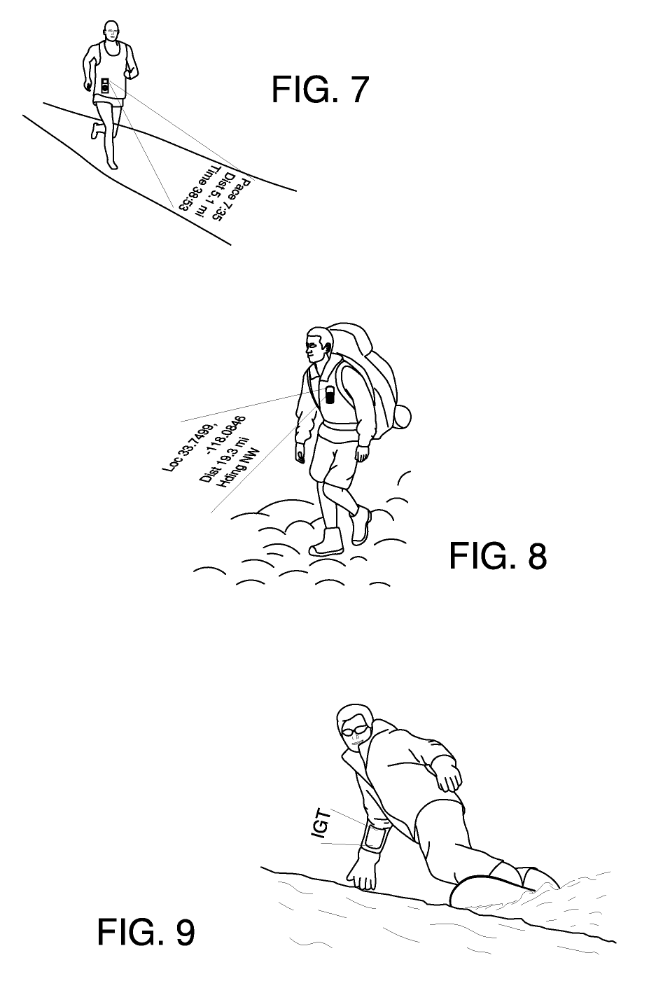

FIGS. 7-9 show various examples of using the projector system for projecting information as may be employed in accordance with certain embodiments of the present application. For example, FIG. 7 shows a runner using the system positioned on an article of clothing to project pace, distance, and total time while running FIG. 8 shows a hiker using the system positioned on a backpack strap while hiking to project GPS coordinates. FIG. 9 shows a snowboarder using the system to project information from a mobile phone onto a screen (positioned on a sleeve of an article of clothing) to project caller ID information. Other uses may include viewing song title, artist, volume level when playing music from electronic device while skiing/snowboarding; projecting pictures on a wall of a tent after a day of hiking while relaxing at a campsite; and viewing videos in a yurt after a day backcountry skiing/snowboarding. Still other arrangements are possible.

While various embodiments have been described, other embodiments are possible. It should be understood that the foregoing descriptions of various examples of the projecting system for use with an article of clothing and/or outdoor recreational apparatus are not intended to be limiting, and any number of modifications, combinations, and alternatives of the examples may be employed.

The examples described herein are merely illustrative, as numerous other embodiments may be implemented without departing from the spirit and scope of the exemplary embodiments of the present application. Moreover, while certain features of the application may be shown on only certain embodiments or configurations, these features may be exchanged, added, and removed from and between the various embodiments or configurations while remaining within the scope of the application. Likewise, methods described and disclosed may also be performed in various sequences, with some or all of the disclosed steps being performed in a different order than described while still remaining within the spirit and scope of the present application.

What is claimed is:

1. An article of clothing, comprising:
a projection system for projecting information, the system comprising:
an electronic device; and
a projector connected to the electronic device,
wherein the electronic device and projector are positionable on the article of clothing to project information therefrom.

2. The article of clothing of claim 1 wherein the projector includes an LED.

3. The article of clothing of claim 1 wherein the projector includes a laser.

4. The article of clothing of claim 1 wherein the projector projects alphanumeric information.

5. The article of clothing of claim 1 wherein the projector projects information onto the ground.

6. The article of clothing of claim 1 wherein the projector projects information onto a wall.

7. The article of clothing of claim 1 wherein the electronic device is selected from the group consisting of portable media players, wireless personal area networks, cell phones, global positioning systems, and personal digital assistants.

8. The article of clothing of claim 1 wherein the system further comprises a power source to power the electronic device selected from the group consisting of batteries and solar power.

9. The article of clothing of claim 1 wherein the system further comprises a connector to connect the electronic device with the projector.

10. The article of clothing of claim 1 further comprising a screen positioned on the article of clothing to enhance the projected information.

11. The article of clothing of claim 1 wherein the article of clothing is selected from the group consisting of a jacket, shirt, and pants.

12. An outdoor recreational apparatus, comprising:
a projection system for projecting information, the system comprising:
an electronic device; and
a projector connected to the electronic device,
wherein the electronic device and projector are positionable on the device to project information therefrom.

13. The apparatus of claim 12 wherein the projector includes an LED.

14. The apparatus of claim 12 wherein the projector includes a laser.

15. The apparatus of claim 12 wherein the projector projects information onto the ground.

16. The apparatus of claim 12 wherein the projector projects information onto a wall.

17. The apparatus of claim 12 wherein the electronic device is selected from the group consisting of portable media players, wireless personal area networks, cell phones, global positioning systems, and personal digital assistants.

18. The apparatus of claim 12 wherein the system further comprises a power source to power the electronic device selected from the group consisting of batteries and solar power.

19. The apparatus of claim 12 wherein the system further comprises a connector to connect the electronic device with the projector.

20. The apparatus of claim 12 wherein the apparatus is selected from the group consisting of a backpack, tent, and sleeping bag.
